(19) United States
(12) Patent Application Publication
(10) Pub. No.: US 2026/0003360 A1
(43) Pub. Date: Jan. 1, 2026

(54) MOVEMENT CONTROL METHOD, PROGRAM, AND MOVEMENT CONTROL SYSTEM

(71) Applicant: MITSUBISHI HEAVY INDUSTRIES, LTD., Tokyo (JP)

(72) Inventor: Kenji Takao, Tokyo (JP)

(73) Assignee: MITSUBISHI HEAVY INDUSTRIES, LTD., Tokyo (JP)

(21) Appl. No.: 18/881,070

(22) PCT Filed: Feb. 24, 2023
(86) PCT No.: PCT/JP2023/006864

§ 371 Date: Jan. 3, 2025

(30) Foreign Application Priority Data
Jul. 26, 2022 (JP) 2022-118455

(51) Int. Cl. G05D 1/43; B64U 10/13; B64U 101/30

(52) U.S. Cl. CPC G05D 1/43; B64U 10/13; B64U 2101/30

(57) ABSTRACT

A movement control method includes: setting a first position toward a first mobile body and a second position that is an evacuation destination of the first mobile body when an abnormality occurs in the first mobile body; setting a first moving route to the first position and a second moving route to the second position; moving a second mobile body including an imaging device to the first position toward the first mobile body based on the first moving route; and moving the first and second mobile bodies to a second position based on the second moving route when the second mobile body reaches the first position. The imaging device captures an image of a surrounding while positioning the second mobile body within a predetermined distance range, until the first mobile body reaches the second position.

### FIELD

The present disclosure relates to a movement control method, a program, and a movement control system.

### BACKGROUND

Movement systems that control the movement of a mobile body that moves automatically have been known. Such a mobile body may not be able to move according to a target route, when an abnormality occurs. For example, Patent Literature 1 discloses that when an unmanned vehicle stops due to an abnormality, a drone is flown to the unmanned vehicle, and on the basis of image data of the unmanned vehicle captured by the drone, it is determined whether the unmanned vehicle can travel according to target travel data.

### CITATION LIST

### Patent Literature

Patent Literature 1: WO 2019/130973

### SUMMARY

### Technical Problem

Here, it is needed to properly move a mobile body in which an abnormality has occurred to a predetermined location such as a shelter, for example.

The present disclosure has been made to solve the above problem, and an object of the present disclosure is to provide a movement control method, a program, and a movement control system that can properly move a mobile body in which an abnormality has occurred to a predetermined location.

### Solution to Problem

A movement control method according to the present disclosure includes the steps of: moving a second mobile body including an imaging device to a first position toward a first mobile body when an abnormality occurs in the first mobile body; and moving the first mobile body to a second position when the second mobile body reaches the first position, wherein the step of moving the first mobile body to the second position includes causing the imaging device to capture an image of a surrounding while positioning the second mobile body within a predetermined distance range from the first mobile body, until the first mobile body reaches the second position.

A program according to the present disclosure causes a computer to execute the steps of: moving a second mobile body including an imaging device to a first position toward a first mobile body when an abnormality occurs in the first mobile body; and moving the first mobile body to a second position when the second mobile body reaches the first position, wherein the step of moving the first mobile body to the second position includes causing the imaging device to capture an image of a surrounding while positioning the second mobile body within a predetermined distance range from the first mobile body, until the first mobile body reaches the second position.

A movement control system according to the present disclosure includes: a first mobile body; and a second mobile body including an imaging device, wherein the second mobile body moves to a first position toward the first mobile body when an abnormality occurs in the first mobile body, the first mobile body moves to a second position when the second mobile body reaches the first position, and the second mobile body causes the imaging device to capture an image of a surrounding while remaining within a predetermined distance range from the first mobile body, until the first mobile body reaches the second position.

### Advantageous Effects of Invention

According to the present disclosure, it is possible to properly move a mobile body in which an abnormality has occurred to a predetermined location.

### BRIEF DESCRIPTION OF DRAWINGS

FIG. 1 is a schematic diagram of a movement control system according to an embodiment.

FIG. 2 is a schematic diagram of a configuration of a mobile body.

FIG. 3 is a schematic block diagram of a first control device.

FIG. 4 is a schematic block diagram of a second control device.

FIG. 5 is a schematic block diagram of a second mobile body.

FIG. 6 is a schematic block diagram of a remote control device.

FIG. 7 is a schematic diagram illustrating the setting of a first position and a second position.

FIG. 8 is a schematic diagram illustrating the movement of the first mobile body and the second mobile body.

FIG. 9 is a schematic diagram illustrating an example of an image displayed on the remote control device.

FIG. 10 is a schematic diagram illustrating an example of an image displayed on the remote control device.

FIG. 11 is a schematic diagram illustrating an example when the first mobile body has reached the second position.

FIG. 12 is a flowchart illustrating a processing flow of the movement control system according to a first embodiment.

FIG. 13 is a schematic diagram illustrating a case when the second mobile body is made to stay on the first mobile body.

FIG. 14 is a flowchart illustrating a processing flow of a movement control system according to a second embodiment.

### DESCRIPTION OF EMBODIMENTS

Hereinafter, preferred embodiments of the present disclosure will be described in detail with reference to the accompanying drawings. It is to be noted that the present disclosure is not limited to the embodiments, and when there are a plurality of embodiments, the embodiments may be combined with one another.

### First Embodiment

### Movement Control System

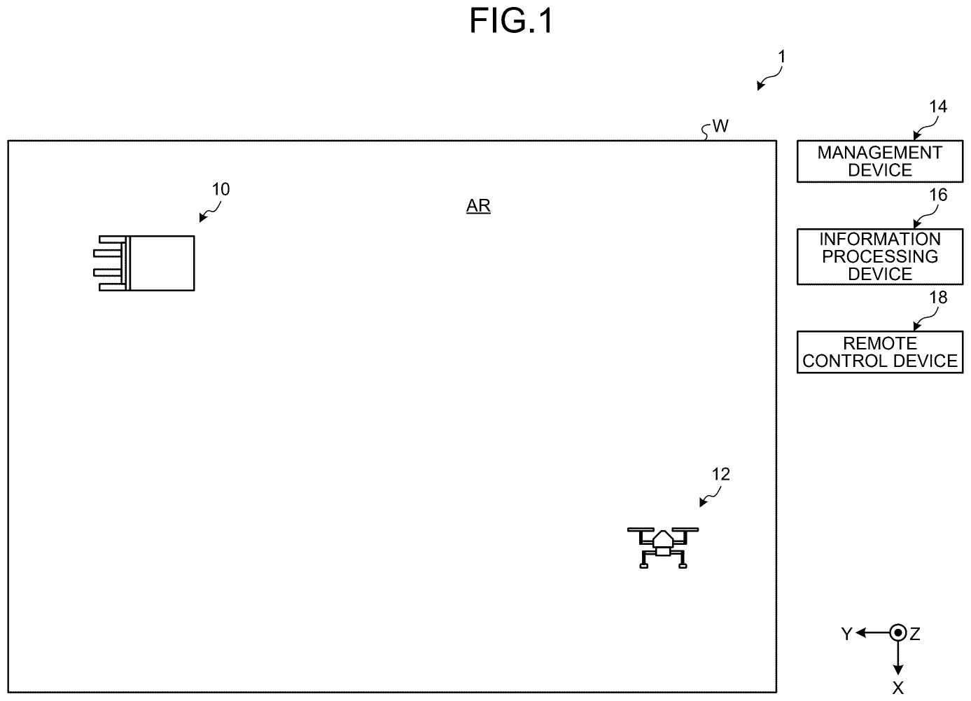

FIG. 1 is a schematic diagram of a movement control system according to the present embodiment. As illustrated in FIG. 1, a movement control system 1 according to the present embodiment includes a first mobile body 10, a second mobile body 12 that assists the movement of the first mobile body 10, a management device 14 that manages a facility W, an information processing device 16 that manages the movement of the first mobile body 10, and a remote control device 18 that remotely controls the first mobile body 10. The movement control system 1 is a system that controls the movement of the first mobile body 10 belonging to the facility W. For example, the facility W is a facility where logistics is managed such as a warehouse. However, the facility W may also be any facility where the first mobile body 10 is used. In the movement control system 1, the first mobile body 10 picks up a target placed in an area AR of the facility W and conveys the target. For example, the area AR is the floor surface of the facility W, and is an area where a target is installed or where the first mobile body 10 moves. In the present embodiment, the target conveyed by the first mobile body 10 is an object to be conveyed, which is goods loaded on a pallet. However, the target is not limited to the goods loaded on a pallet, and may also be in any form. For example, the target may simply be goods without a pallet. Moreover, the first mobile body 10 is not limited to the one that conveys a target, but may also be a device that moves in the facility W for any purpose.

In the following, one direction along the area AR is referred to as an X direction, and a direction along the area AR and that intersects the direction X is referred to as a Y direction. In the present embodiment, the Y direction is a direction orthogonal to the X direction. The X direction and the Y direction may also be referred to as directions along the horizontal plane. Moreover, a direction orthogonal to the X direction and the Y direction, further specifically, a direction vertically upward is referred to as a Z direction. Furthermore, in the present embodiment, unless otherwise specified, a “position” indicates a position (coordinates) in a coordinate system on a two-dimensional plane on the area AR (coordinate system of the area AR). Still furthermore, unless otherwise specified, a “posture” of the first mobile body 10 or the like indicates the orientation of the first mobile body 10 or the like in the coordinate system of the area AR, and when viewed from the Z direction, is the yaw angle (rotation angle) of the first mobile body 10, when the X direction is set to 0 degree.

### First Mobile Body

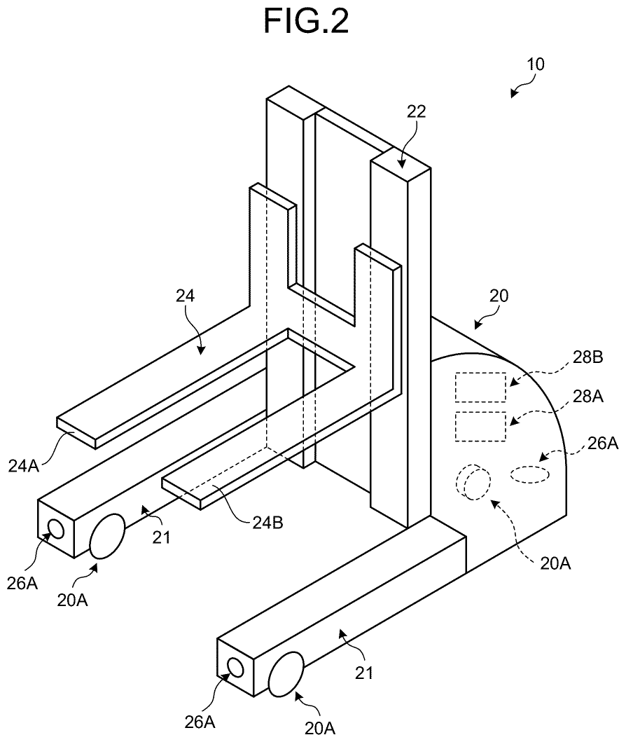

FIG. 2 is a schematic diagram of a configuration of the mobile body. The first mobile body 10 is a device that can move automatically, and that can convey a target Q. More specifically, in the present embodiment, the first mobile body 10 is a forklift, and further specifically, the first mobile body 10 is what is called an automated guided vehicle (AGV) or an automated guided forklift (AGF). However, the first mobile body 10 need not always be a forklift that conveys the target Q, and may be any device that can move automatically. The number of the first mobile bodies 10 in the facility W is optional. However, for example, it is preferable that a plurality of first mobile bodies 10 are deployed.

As illustrated in FIG. 2, the first mobile body 10 includes a vehicle body 20, wheels 20A, straddle legs 21, a mast 22, a fork 24, a sensor 26A, a first control device 28A, and a second control device 28B. The straddle legs 21 are a pair of shaft-like members provided on one end of the vehicle body 20 in the front-back direction, and that protrudes from the vehicle body 20. The wheels 20A are provided on the front ends of the respective straddle legs 21, and on the vehicle body 20. That is, there are a total of three wheels 20A. However, the positions and number of the wheels 20A are optional. The mast 22 is movably attached to the straddle legs 21, and moves in the front-back direction of the vehicle body 20. The mast 22 extends along the up-down direction (in this example, the direction Z) that is orthogonal to the front-back direction. The fork 24 is movably attached to the mast 22 in the direction Z. The fork 24 may also be movable in the lateral direction of the vehicle body 20 (direction intersecting the up-down direction and the front-back direction) with respect to the mast 22. The fork 24 has a pair of claws 24A and 24B. The claws 24A and 24B extend from the mast 22 in the forward direction of the vehicle body 20. The claw 24A and the claw 24B are disposed apart from each other in the lateral direction of the mast 22. Hereafter, in the front-back direction, the direction of the side where the fork 24 is provided in the first mobile body 10 is referred to as the forward direction, and the direction of the side where the fork 24 is not provided is referred to as the backward direction.

### First Control Device

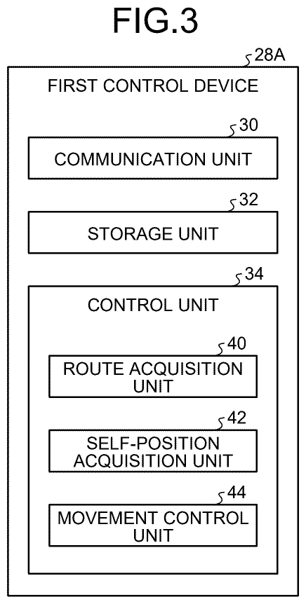

FIG. 3 is a schematic block diagram of the first control device. The first control device 28A is a device that controls the first mobile body 10. The first control device 28A acquires information on a route along which the first mobile body 10 moves, and causes the first mobile body 10 to move autonomously. The first control device 28A is a computer, and as illustrated in FIG. 3, includes a communication unit 30, a storage unit 32, and a control unit 34. The communication unit 30 is a module used for the control unit 34, and that communicates with an external device such as the information processing device 16 and the remote control device 18. For example, the communication unit 30 may include an antenna and the like. In the present embodiment, the communication method used by the communication unit 30 is wireless communication. However, any communication method may be used. The storage unit 32 is a memory that stores various types of information such as calculation contents and computer programs of the control unit 34. For example, the storage unit 32 includes at least one of a main storage device such as a random access memory (RAM) and a read only memory (ROM), and an external storage device such as a hard disk drive (HDD).

The control unit 34 is an arithmetic device, and for example, includes an arithmetic circuit such as a central processing unit (CPU). The control unit 34 includes a route acquisition unit 40, a self-position acquisition unit 42, and a movement control unit 44. The control unit 34 implements the route acquisition unit 40, the self-position acquisition unit 42, and the movement control unit 44, and executes the processing, by reading and executing a computer program (software) from the storage unit 32. It is to be noted that the control unit 34 may execute the processing by a single CPU, or may include a plurality of CPUs and execute the processing by the CPUs. Moreover, at least part of the route acquisition unit 40, the self-position acquisition unit 42, and the movement control unit 44 may be implemented by a hardware circuit. Furthermore, a computer program for the control unit 34 stored in the storage unit 32 may be stored in a recording medium that can be read by the first control device 28A.

The route acquisition unit 40 acquires information on the route along which the first mobile body 10 moves, the self-position acquisition unit 42 acquires information on the position of the first mobile body 10, and the movement control unit 44 controls the movement of the first mobile body 10 by controlling a drive unit and a movement mechanism such as steering of the first mobile body 10. Specific processing contents will be described later.

### Second Control Device

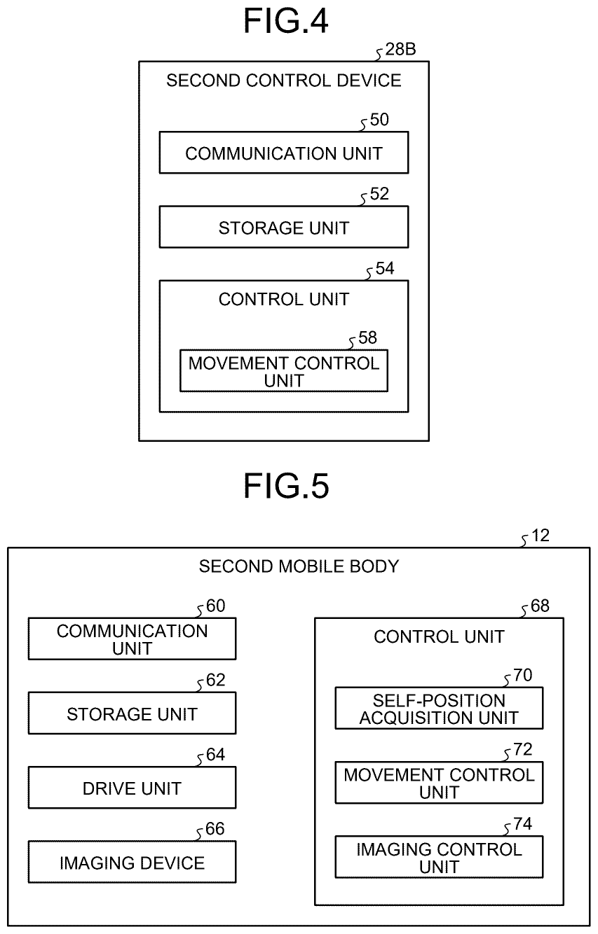

FIG. 4 is a schematic block diagram of the second control device. The second control device 28B is a device that controls the first mobile body 10. The second control device 28B receives a remote control signal from the remote control device 18, and moves the first mobile body 10 according to the signal from the remote control device 18. The second control device 28B is a computer, and as illustrated in FIG. 3, includes a communication unit 50, a storage unit 52, and a control unit 54. The communication unit 50 is a module used for the control unit 54, and communicates with an external device such as the remote control device 18. For example, the communication unit 50 may include an antenna and the like. In the present embodiment, the communication method used by the communication unit 50 is wireless communication. However, any communication method may be used. The storage unit 52 is a memory that stores various types of information such as calculation contents and computer programs of the control unit 54. For example, the storage unit 52 includes at least one of a main storage device such as a RAM and a ROM, and an external storage device such as an HDD.

The control unit 54 is an arithmetic device, and for example, includes an arithmetic circuit such as a CPU. The control unit 54 includes a movement control unit 58. The control unit 54 implements the movement control unit 58 and executes the processing, by reading and executing a computer program (software) from the storage unit 52. It is to be noted that the control unit 54 may execute the processing by a single CPU, or may include a plurality of CPUs and execute the processing by the CPUs. Moreover, at least part of the movement control unit 58 may be implemented by a hardware circuit. Furthermore, a computer program for the control unit 54 stored in the storage unit 52 may be stored in a recording medium that can be read by the second control device 28B.

The movement control unit 58 acquires a signal for remotely controlling the first mobile body 10 from the remote control device 18, and moves the first mobile body 10, by controlling the movement mechanism of the first mobile body 10, with the control contents indicated by the signal acquired by the signal acquisition unit 56. Specific processing contents will be described later.

In this manner, in the present embodiment, the first control device 28A that autonomously controls the first mobile body 10, and the second control device 28B that remotely controls the first mobile body 10 are different pieces of hardware. In this manner, when the first control device 28A and the second control device 28B are different pieces of hardware, for example, even if an abnormally occurs and the first control device 28A becomes completely inoperable, the second control device 28B can most likely be maintained in a normal state, and the first mobile body 10 can be remotely controlled in a proper manner. However, the first control device 28A and the second control device 28B need not be different pieces of hardware, and may be one piece of hardware. That is, for example, the first control device 28A may have the functions of the movement control unit 58.

### Second Mobile Body

The second mobile body 12 is a device that can move automatically. In an example of the present embodiment, the second mobile body 12 is a flying object that can fly in the air such as a drone, for example. However, it is not limited thereto, and the second mobile body 12 may also be a vehicle, a robot, or the like that moves on the ground. The number of the second mobile bodies 12 in the facility W is optional. However, for example, it is preferable that the number of the second mobile bodies 12 is less than the number of the first mobile bodies 10.

FIG. 5 is a schematic block diagram of the second mobile body. As illustrated in FIG. 5, the second mobile body 12 includes a communication unit 60, a storage unit 62, a drive unit 64, an imaging device 66, and a control unit 68. The communication unit 60 is a module used for the control unit 68, and communicates with an external device such as the remote control device 18. For example, the communication unit 60 may include an antenna and the like. In the present embodiment, the communication method used by the communication unit 60 is wireless communication. However, any communication method may be used. The storage unit 62 is a memory that stores various types of information such as calculation contents and computer programs of the control unit 68. For example, the storage unit 62 includes at least one of a main storage device such as a RAM and a ROM, and an external storage device such as an HDD.

The drive unit 64 is a drive device that moves the second mobile body 12. The imaging device 66 is a camera that captures an image of the surroundings. The number of the imaging devices 66 and the position of each imaging device 66 provided on the second mobile body 12 are optional. For example, in the present embodiment, as the imaging device 66, it is preferable to provide an imaging device (first imaging device) that captures an image on the traveling direction side of the second mobile body 12, and an imaging device (second imaging device) that captures an image on the side opposite to the traveling direction of the second mobile body 12. More specifically, as the imaging device 66, it is more preferable to provide an imaging device (third imaging device) that captures an image on one side in the left-right direction that is orthogonal to the traveling direction and the up-down direction of the second mobile body 12, and an imaging device (fourth imaging device) that captures an image on the other side in the left-right direction, in addition to the first imaging device and the second imaging device.

The control unit 68 is an arithmetic device, and for example, includes an arithmetic circuit such as a CPU. The control unit 68 includes a self-position acquisition unit 70, a movement control unit 72, and an imaging control unit 74. The control unit 68 implements the self-position acquisition unit 70, the movement control unit 72, and the imaging control unit 74, and executes the processing by reading and executing a computer program (software) from the storage unit 52. It is to be noted that the control unit 68 may execute the processing by a single CPU, or may include a plurality of CPUs and execute the processing by the CPUs. Moreover, at least part of the self-position acquisition unit 70, the movement control unit 72, and the imaging control unit 74 may be implemented by a hardware circuit. Furthermore, a computer program for the control unit 68 stored in the storage unit 62 may be stored in a recording medium that can be read by the second mobile body 12.

The self-position acquisition unit 70 acquires information on the position of the second mobile body 12, the movement control unit 72 controls the movement of the second mobile body 12 by controlling the drive unit 64, and the imaging control unit 74 controls the imaging device 66 and causes the imaging device 66 to capture an image. Specific processing contents will be described later.

### Management Device

The management device 14 is a system that manages logistics in the facility W. For example, the management device 14 sets work contents of the first mobile body 10, and control contents of a mechanism other than the first mobile body 10 provided in the facility W (for example, elevator, door, or the like). In the present embodiment, the management device 14 is a warehouse control system (WCS) or a warehouse management system (WMS). However, the management device 14 is not limited to the WCS and the WMS, and may be any system. For example, the management device 14 may be a back-end system such as another production management system. The position of the management device 14 is optional. The management device 14 may be provided in the facility W or may be provided at a position distant from the facility W, and may manage the facility W from the distant position.

### Information Processing Device

The information processing device 16 is a system that manages logistics in the facility W. The information processing device 16 is a device that processes information on the movement of the first mobile body 10 and the like. For example, the information processing device 16 is a fleet control system (FCS). However, it is not limited thereto, and the information processing device 16 may be any device that processes information on the movement of the first mobile body 10. In the present embodiment, the information processing device 16 is provided in the facility W. However, the position of the information processing device 16 is optional.

The information processing device 16 sets a reference route of the first mobile body 10. The reference route is a route connecting the locations at known positions. For example, in the area AR, a waypoint is set at each position (coordinates), and the reference route is set by connecting the waypoints. The waypoints are set according to the layout of the facility W.

### Remote Control Device

The remote control device 18 is a device provided at a position distant from the first mobile body 10, and remotely controls the first mobile body 10. The remote control device 18 remotely controls a plurality of the first mobile bodies 10. However, it is not limited thereto, and the remote control device 18 may also be provided for each of the first mobile bodies 10.

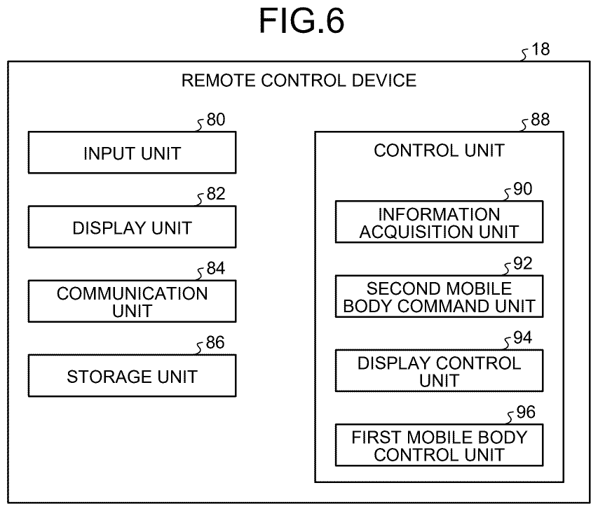

FIG. 6 is a schematic block diagram of the remote control device. The remote control device 18 is a computer, and as illustrated in FIG. 6, includes an input unit 80, a display unit 82, a communication unit 84, a storage unit 86, and a control unit 88. The input unit 80 is a mechanism that receives an operation of an operator, and for example, may include a mouse, a keyboard, a touch panel, and the like, or may include a controller that remotely operates the first mobile body 10. The display unit 82 is a display for displaying an image. The communication unit 84 is a module used for the control unit 88, and communicates with an external device such as the first mobile body 10. For example, the communication unit 84 may include an antenna and the like. In the present embodiment, the communication method used by the communication unit 84 is wireless communication. However, any communication method may be used. The storage unit 86 is a memory that stores various types of information such as calculation contents and computer programs of the control unit 88. For example, the storage unit 86 includes at least one of a main storage device such as a RAM and a ROM, and an external storage device such as an HDD.

The control unit 88 is an arithmetic device, and for example, includes an arithmetic circuit such as a CPU. The control unit 88 includes an information acquisition unit 90, a second mobile body command unit 92, a display control unit 94, and a first mobile body control unit 96. The control unit 88 implements the information acquisition unit 90, the second mobile body command unit 92, the display control unit 94, and the first mobile body control unit 96, and executes the processing by reading and executing a computer program (software) from the storage unit 86. It is to be noted that the control unit 88 may execute the processing by a single CPU, or may include a plurality of CPUs and execute the processing by the CPUs. Moreover, at least part of the information acquisition unit 90, the second mobile body command unit 92, the display control unit 94, and the first mobile body control unit 96 may be implemented by a hardware circuit. Furthermore, a computer program for the control unit 88 stored in the storage unit 86 may be stored in a recording medium that can be read by the remote control device 18.

The information acquisition unit 90 acquires various types of information from an external device (for example, the first mobile body 10 and the second mobile body 12) via the communication unit 84. The second mobile body command unit 92 generates a command signal for the second mobile body 12, and causes the second mobile body 12 to perform an operation such as moving, by transmitting the command signal to the second mobile body 12. The display control unit 94 causes the display unit 82 to display an image captured by the imaging device 66 of the second mobile body 12 or the like. The first mobile body control unit 96 generates a signal to remotely control the first mobile body 10, and remotely controls the first mobile body 10 by transmitting the signal to the first mobile body 10. Specific processing contents will be described later.

In the present embodiment, the remote control device 18 remotely controls both the first mobile body 10 and the second mobile body 12, by including the first mobile body control unit 96 and the second mobile body command unit 92. However, the first mobile body 10 and the second mobile body 12 need not always be remotely controlled by one piece of hardware. The remote control device 18 may be a system that includes hardware having the functions of the first mobile body control unit 96 that remotely controls the first mobile body 10, and hardware having the functions of the second mobile body command unit 92 that remotely controls the second mobile body 12.

Moreover, in the present embodiment, the management device 14, the information processing device 16, and the remote control device 18 are different pieces of hardware. However, at least two of the management device 14, the information processing device 16, and the remote control device 18 may be integrated hardware. That is, the management device 14 may also have at least part of the functions of the information processing device 16 and the remote control device 18, the information processing device 16 may also have at least part of the functions of the management device 14 and the remote control device 18, and the remote control device 18 may also have at least part of the functions of the management device 14 and the information processing device 16.

### Processing of Movement Control System

The processing contents of the movement control system 1 will now be described.

### Acquisition of Route

The first control device 28A of the first mobile body 10 uses the route acquisition unit 40 to acquire information on the route along which the first mobile body 10 moves. The route acquisition unit 40 acquires information on the route of the first mobile body 10 to reach the target point. In this example, the target point may be optionally set. For example, the target point may be set on the basis of the work contents of the first mobile body 10. The route acquisition unit 40 may acquire the route using any method. For example, the information processing device 16 may set information on the reference route indicating the waypoints to the target point, and the route acquisition unit 40 may acquire the information on the reference route set by the information processing device 16, as the information on the route. Moreover, for example, the route acquisition unit 40 itself may set the route on the basis of the information on the target point.

### Moving First Mobile Body

The first control device 28A of the first mobile body 10 uses the movement control unit 44 to move the first mobile body 10 according to the acquired route. In this case, the first control device 28A uses the self-position acquisition unit 42 to move the first mobile body 10 such that the first mobile body 10 passes the route (in this case, the waypoints set as the route), by sequentially obtaining the position information of the first mobile body 10 (for example, position and posture of the first mobile body 10). The method of acquiring the position information of the first mobile body 10 is optional. For example, in the present embodiment, a detection body, which is not illustrated, is provided in the facility W. The self-position acquisition unit 42 acquires information on the position and posture of the first mobile body 10 on the basis of the detection of the detection body. Specifically, the first mobile body 10 detects the position and posture of the first mobile body 10 in the facility W by emitting a laser beam toward the detection body and receiving the laser beam reflected by the detection body. A detection body need not always be used in the method of acquiring information on the position and posture of the first mobile body 10, and for example, simultaneous localization and mapping (SLAM) may also be used.

It is to be noted that the first mobile body 10 is not limited to movement according to the waypoints. For example, when the first mobile body 10 that has moved according to the waypoints reaches the vicinity of the target, the movement control unit 44 may cause the sensor 26A to detect the position and posture of the target, set the route to the target on the basis of the detection results, and approach the target according to the route.

### Abnormality in First Mobile Body

In this example, the first mobile body 10 may not be able to move autonomously according to the route, when an abnormality occurs. The abnormality in the first mobile body 10 in the present embodiment does not refer to an event in which the first mobile body 10 cannot move from the spot due to a failure in a drive system of the first mobile body 10, but refers to an event in which the first mobile body 10 can move from the spot but cannot move autonomously along the route. For example, the abnormality in the first mobile body 10 includes an event in which the first control device 28A cannot control the autonomous movement of the first mobile body 10 due to an abnormality in the first control device 28A, an event in which the first control device 28A can control the movement of the first mobile body 10, but cannot detect the position of the first mobile body 10, and the first mobile body 10 cannot move autonomously along the route, and the like.

In the present embodiment, when the first mobile body 10 cannot move autonomously according to the route, the second mobile body 12 is moved to the vicinity of the first mobile body 10, and the movement of the first mobile body 10 is assisted by the second mobile body 12. Hence, the first mobile body 10 is properly moved to a predetermined moving destination (second position). Specifically, when an abnormality occurs in the first mobile body 10, the second mobile body 12 is moved to a first position A toward the first mobile body 10, and then causes the imaging device 66 to capture an image of the surroundings, while the second mobile body 12 is positioned within a predetermined distance range from the first mobile body 10, until the first mobile body 10 reaches a second position B. Consequently, it is possible to properly move (guide) the first mobile body 10 to the second position B. Hereinafter, a process of moving the first mobile body 10 to the second position B will be described in detail.

### Acquisition of Abnormality Information

When an abnormality occurs, the first mobile body 10 transmits abnormality information indicating that an abnormality has occurred in the first mobile body 10, to the remote control device 18. The abnormality information may include a content indicating the type of abnormality in addition to the content indicating the occurrence of abnormality. When an abnormality occurs, the first mobile body 10 may stop moving, and transmit an abnormality signal to the remote control device 18 in a stopped state. The abnormality information is transmitted by the first control device 28A or the second control device 28B via the communication unit 50. The information acquisition unit 90 of the remote control device 18 acquires the abnormality information from the first mobile body 10.

### Setting of First Position

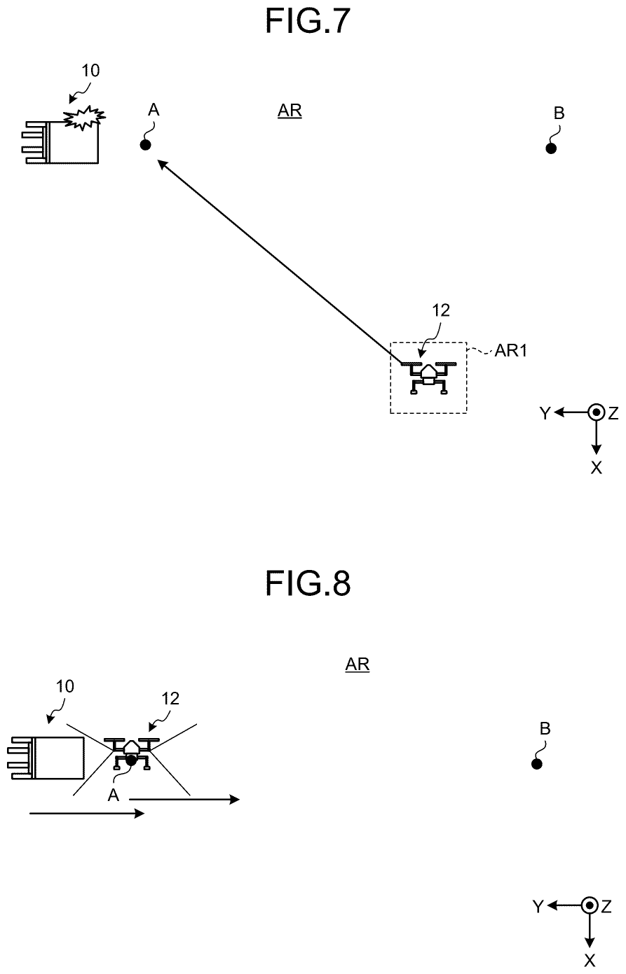

FIG. 7 is a schematic diagram illustrating the setting of the first position and the second position. When abnormality information is acquired by the information acquisition unit 90 from the first mobile body 10, the remote control device 18 uses the second mobile body command unit 92 to set the first position A. As illustrated in FIG. 7, the first position A is a destination toward which the second mobile body 12 proceeds, and indicates a predetermined position from the first mobile body 10 in which an abnormality has occurred. The first position A may be referred to as a position in the vicinity of the first mobile body 10 in which an abnormality has occurred. For example, the first position A may be a position within a predetermined distance range from the first mobile body 10 in which an abnormality has occurred. More specifically, the first position A may be a position where the imaging device 66 of the second mobile body 12 can capture an image of the first mobile body 10. In this case, for example, the second mobile body command unit 92 of the remote control device 18 acquires the position information of the first mobile body 10, and sets a predetermined position (for example, a position within a predetermined distance range) from the position of the first mobile body 10 indicated by the position information of the first mobile body 10, as the first position A. The second mobile body command unit 92 may acquire the position information of the first mobile body 10 using any method. For example, if the first mobile body 10 in which an abnormality has occurred can acquire its own position, the second mobile body command unit 92 may acquire the position information of the first mobile body 10 in which an abnormality has occurred, from the first mobile body 10. Moreover, if the first mobile body 10 cannot acquire its own position, the second mobile body command unit 92 may acquire the position information of the first mobile body 10 last acquired by the first mobile body 10.

The first position A may be set by an operator, or may be automatically set by the remote control device 18. When the first position A is set by an operator, for example, the position of the first mobile body 10 is displayed on the display unit 82 on the basis of the position information of the first mobile body 10. The operator checks the position of the first mobile body 10, and inputs an operation of specifying the first position A to the input unit 80. The second mobile body command unit 92 sets the first position A input to the input unit 80, as the first position A. Moreover, when the first position A is set automatically, the second mobile body command unit 92 sets a predetermined position from the first mobile body 10, as the first position A, on the basis of the position information of the first mobile body 10.

### Setting of Second Position

In the present embodiment, when abnormality information is acquired from the first mobile body 10, the remote control device 18 uses the second mobile body command unit 92 to also set the second position B. The second position B is a moving destination toward which the first mobile body 10 in which an abnormality has occurred proceeds. The second mobile body command unit 92 may set any position as the second position B. For example, the second mobile body command unit 92 may set a position set in advance as an evacuation destination of the first mobile body 10 in which an abnormality has occurred, as the second position B. In this case, for example, there are a plurality of candidates for the evacuation destination, and the second mobile body command unit 92 may set any of the evacuation destinations as the second position B. However, the second position B need not always be the same as the position of the evacuation destination, and the second mobile body command unit 92 may set a position within a predetermined distance range from the evacuation destination, as the second position B.

The second position B may be set by an operator, or may be automatically set by the remote control device 18. When the second position B is set by an operator, for example, the operator inputs an operation of specifying the second position B to the input unit 80. The second mobile body command unit 92 sets the second position B input to the input unit 80, as the second position B.

### Moving Second Mobile Body to First Position

The second mobile body command unit 92 of the remote control device 18 transmits information on the first position A and the second position B, to the second mobile body 12. Upon acquiring the information on the first position A and the second position B, as illustrated in FIG. 7, the second mobile body 12 uses the movement control unit 72 to start moving to the first position A. In the example in FIG. 7, the second mobile body 12 is positioned at a predetermined standby position AR1, and upon acquiring the information on the first position A and the second position B, the second mobile body 12 moves from the standby position AR1 toward the first position A. It is to be noted that the second mobile body 12 also uses the self-position acquisition unit 70 to move the second mobile body 12, while sequentially obtaining the position information of the second mobile body 12 (for example, position and posture of the second mobile body 12). The method of acquiring position information of the second mobile body 12 is optional. However, for example, the same method as that of the first mobile body 10 may be used.

The moving route of the second mobile body 12 to the first position A may be optionally set. For example, the second mobile body 12 may set the shortest route (for example, a linear route) from the standby position AR1 to the first position A, as the moving route to the first position A, and move according to the moving route. Moreover, for example, the second mobile body 12 may acquire the reference route for the first mobile body 10 from the information processing device 16, and use the acquired reference route as the moving route to the first position A. In this case, for example, the second mobile body 12 acquires the reference route from the waypoint corresponding to the standby position AR1 to the waypoint corresponding to the first position A, as the moving route. Furthermore, for example, if the first position A is deviated from a waypoint, the second mobile body 12 may move according to the reference route up to the waypoint closest to the first position A, set a route from the waypoint to the first position A, and move to the first position A.

Upon reaching the first position A, the second mobile body 12 transmits information indicating that the second mobile body 12 has reached the first position A, to the remote control device 18. Upon acquiring the information indicating that the second mobile body 12 has reached the first position A, the second mobile body command unit 92 of the remote control device 18 outputs a start command to start assisting the movement of the first mobile body 10, to the second mobile body 12.

It is to be noted that the second mobile body command unit 92 of the remote control device 18 may remotely control at least one of the position and posture of the second mobile body 12 that has reached the first position A. In this case, for example, the second mobile body 12 that has reached the first position A uses the imaging control unit 74 to cause the imaging device 66 to capture an image, and transmits the image captured by the imaging device 66 to the remote control device 18. The display control unit 94 of the remote control device 18 remotely controls at least one of the position and posture of the second mobile body 12, on the basis of the image captured by the imaging device 66. The second mobile body command unit 92 may remotely control the second mobile body 12 by an operation of an operator, or may remotely control the second mobile body 12 automatically. For example, when an operator remotely controls the second mobile body 12, the display control unit 94 of the remote control device 18 causes the display unit 82 to display the image captured by the imaging device 66. Then, while viewing the image captured by the imaging device 66 displayed on the display unit 82, the operator inputs an operation of controlling at least one of the position and posture of the second mobile body 12, to the input unit 80. The second mobile body command unit 92 generates a control signal indicating the operation contents of the second mobile body 12 input by the operator, and transmits the generated control signal to the second mobile body 12. The movement control unit 72 of the second mobile body 12 receives the control signal, and controls the movement of the second mobile body 12 such that the position and posture of the second mobile body 12 correspond to the control signal. Moreover, when the remote control device 18 remotely controls the second mobile body 12 automatically, for example, the second mobile body command unit 92 controls the second mobile body 12 by generating a control signal indicating the operation contents of the second mobile body 12 on the basis of the image captured by the imaging device 66. In this case, for example, it is preferable that the second mobile body command unit 92 controls the second mobile body 12 by generating a control signal such that the position and posture of the second mobile body 12 are set so that the first mobile body 10 is captured in the image captured by the imaging device 66.

Moreover, in the above description, the second mobile body 12 that has reached the first position A is remotely controlled. However, the second mobile body command unit 92 of the remote control device 18 may remotely control the movement of the second mobile body 12 to the first position A. The method of remotely controlling the second mobile body 12 to move to the first position A is the same as the method of remotely controlling the second mobile body 12 that has reached the first position A, except that the second mobile body 12 is to be moved to the first position A. Hence, description thereof will be omitted. Moreover, for example, the second mobile body command unit 92 of the remote control device 18 may set a moving route of the second mobile body 12 to the first position A, and cause the second mobile body 12 to move along the set moving route. The method of setting the moving route by the second mobile body command unit 92 is optional. For example, the moving route may be automatically set by the second mobile body command unit 92, or may be set by an operator.

### Moving Second Mobile Body to Second Position

FIG. 8 is a schematic diagram illustrating the movement of the first mobile body and the second mobile body. Upon receiving a start command from the remote control device 18, as illustrated in FIG. 8, the second mobile body 12 starts moving toward the second position B, while causing the imaging device 66 to capture an image. The second mobile body 12 sequentially transmits image data captured by the imaging device 66 while moving toward the second position B, to the remote control device 18. It is to be noted that the target position of the second mobile body 12 need not always be the second position B. For example, the target position may be a position within a predetermined distance range from the second position B, and the second mobile body 12 may move toward the second position B.

The moving route of the second mobile body 12 to the second position B may be optionally set. For example, the second mobile body 12 may set the shortest route (for example, a linear route) to the second position B as the moving route to the second position B, and move according to the moving route. Moreover, for example, the second mobile body 12 may acquire the reference route for the first mobile body 10 from the information processing device 16, and use the acquired reference route as the moving route to the second position B. In this case, for example, the second mobile body 12 acquires the reference route from the waypoint corresponding to the first position A to the waypoint corresponding to the second position B, as the moving route. Furthermore, for example, if the second position B is deviated from a waypoint, the second mobile body 12 may move according to the reference route up to the waypoint closest to the second position B, set a route from the waypoint to the second position B, and move to the second position B. More specifically, to move to the second position B while guiding the first mobile body 10, the second mobile body 12 may preferably move along the widest path possible. Thus, for example, among the reference routes by which the second position B can be reached, the reference route with a wide path through which the route passes, may be set as the moving route to the second position B. The method of selecting the reference route with a wide path is optional. For example, the reference route with the largest average value of the path width may be selected among the reference routes by which the second position B can be reached, or the reference route with the smallest value of the path width being equal to or greater than a threshold value may be selected. In this case, it is preferable to select the reference route with a wide path, even if the distance is increased. It is to be noted that the width of a path may be stored in the information processing device 16 or the like in advance, as map information, for example. Moreover, in this example, a route with a wide path is selected among the reference routes. However, the reference routes need not always be used, and for example, a route with a wide path may be set from map information.

### Display of Image

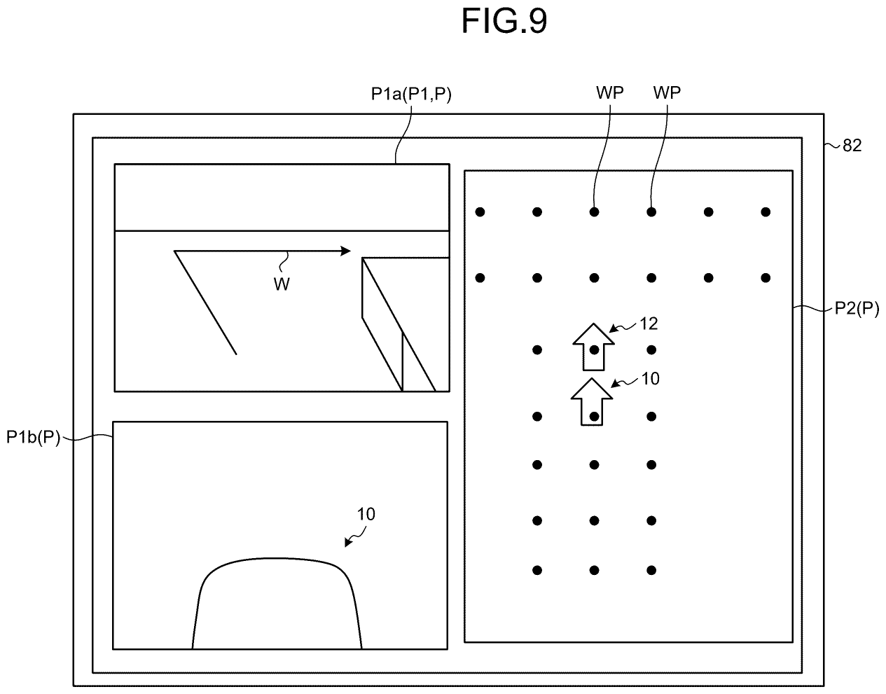

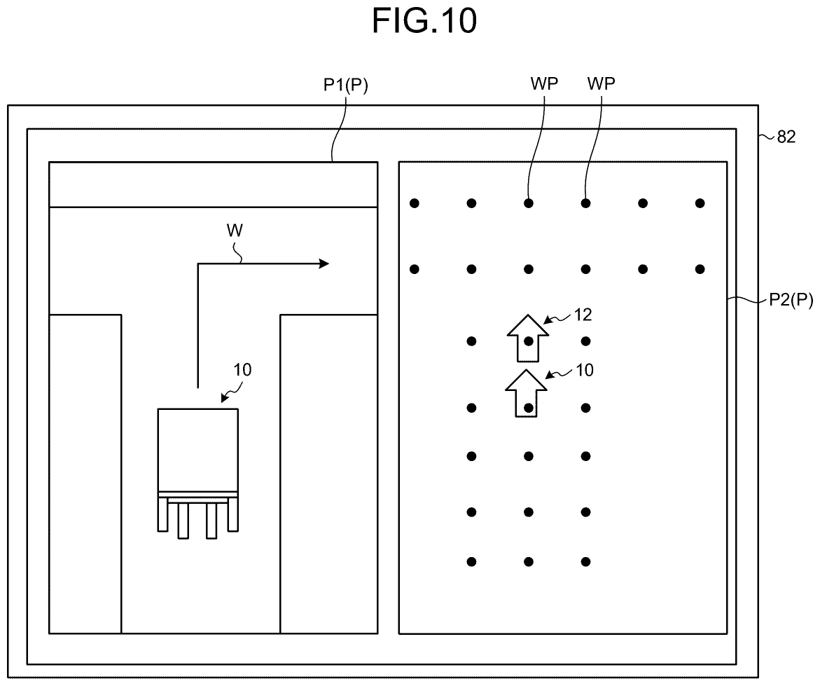

FIG. 9 and FIG. 10 are each a schematic diagram illustrating an example of an image displayed on the remote control device. The display control unit 94 of the remote control device 18 acquires image data captured by the imaging device 66 while moving toward the second position B, and causes the display unit 82 to display an image P. It is preferable that the display control unit 94 causes the display unit 82 to display an image P1 and an image P2, as the image P to be displayed. The image P1 is an image based on the image data captured by the imaging device 66, and is updated each time an image is acquired from the imaging device 66. In the present embodiment, the imaging device 66 for capturing an image on the traveling direction side of the second mobile body 12, and the imaging device 66 for capturing an image on the side opposite to the traveling direction are provided. Hence, as illustrated in FIG. 9, the display control unit 94 may display, as the image P1, a captured image P1a on the traveling direction side of the second mobile body 12 captured by the imaging device 66, and a captured image P1b on the side opposite to the traveling direction captured by the imaging device 66. It is to be noted that the second mobile body 12 moves from the first position A toward the second position B before the first mobile body 10 does. Hence, the first mobile body 10 is captured in the captured image P1b on the side opposite to the traveling direction. Moreover, as illustrated in FIG. 10, the display control unit 94 may display an overhead view image indicating the first mobile body 10 and the surroundings (an image of the first mobile body 10 and the surroundings viewed from the Z direction), as the image P1. In this case, for example, the display control unit 94 may generate an overhead view image indicating the first mobile body 10 and the surroundings from image data captured by each of the imaging devices 66 (for example, first to fourth imaging devices) that have captured images of different positions, and display the overhead view image as the image P1. It is to be noted that as illustrated in FIG. 9 and FIG. 10, the display control unit 94 may also display an image W indicating the route of the second mobile body 12 to the second position B such that the image W is superimposed on the image P1. Moreover, an image indicating the forward direction, backward direction, left direction, and right direction when the traveling direction is the forward direction, an image indicating each direction of north, south, east, and west, and the like, may also be displayed on the image P1 in a superimposed manner. By displaying such an image in a superimposed manner, it is possible to assist the operation of the operator more preferably.

Moreover, the image P2 is an image indicating the position of the second mobile body 12. For example, the display control unit 94 sequentially acquires the position information of the second mobile body 12 from the second mobile body 12, and displays an image indicating the position of the second mobile body 12 in the two-dimensional coordinate system in the X direction and the Y direction, as the image P2. In this case, the position of the second mobile body 12 indicated in the image P2 is sequentially updated according to the position information of the second mobile body 12. It is to be noted that in the examples of FIG. 9 and FIG. 10, the position of each of waypoints WP and the position of the second mobile body 12 in the two-dimensional coordinates in the X direction and Y direction are displayed as the image P2. Moreover, if the first mobile body 10 can acquire its own position, the display control unit 94 may sequentially acquire the position information of the first mobile body 10 from the first mobile body 10, and display an image indicating the position of the first mobile body 10 in the image P2.

### Moving First Mobile Body

When the second mobile body 12 starts moving toward the second position B, the first mobile body 10 starts moving so as to follow the second mobile body 12, and moves toward the second position B. In the present embodiment, the first mobile body 10 moves toward the second position B, by remote control by the remote control device 18. In this case, for example, while viewing the image P displayed on the display unit 82, the operator inputs, to the input unit 80, an operation of controlling at least one of the position and posture of the first mobile body 10 such that the first mobile body 10 moves to the second position B by following the second mobile body 12. The first mobile body control unit 96 of the remote control device 18 generates a control signal indicating the operation contents of the first mobile body 10 input by the operator, and transmits the generated control signal to the first mobile body 10. The movement control unit 58 of the first mobile body 10 receives the control signal, and controls the movement of the first mobile body 10 such that the position and posture of the first mobile body 10 correspond to the control signal.

Specifically, while viewing the image P, the operator remotely operates the first mobile body 10 such that the first mobile body 10 tails (follows) the second mobile body 12 that is moving toward the second position B. For example, the image captured by the imaging device 66 is displayed as the image P1. Hence, by remotely operating the first mobile body 10 such that the first mobile body 10 is kept captured in the image P1, it is possible to allow the first mobile body 10 to properly tail the second mobile body 12. Moreover, for example, the image P1 in the traveling direction of the second mobile body 12, the image P2 indicating the position of the second mobile body 12, the image W indicating the route, and the like are displayed. Hence, the operator can properly move the first mobile body 10 to the target moving destination by remotely operating the first mobile body 10 that is tailing the second mobile body 12, while identifying the approximate position of the first mobile body 10.

Moreover, the first mobile body control unit 96 of the remote control device 18 may remotely control the first mobile body 10 automatically. In this case, for example, it is preferable that the first mobile body control unit 96 controls the first mobile body 10 by generating a control signal such that the first mobile body 10 tails the second mobile body 12, that is, for example, the distance from the second mobile body 12 is kept within a predetermined distance range. It is to be noted that the method of measuring the distance between the first mobile body 10 and the second mobile body 12 is optional. For example, the distance may be calculated on the basis of the image of the first mobile body 10 captured by the imaging device 66.

### Behavior of Second Mobile Body

In this example, the second mobile body 12 moves toward the second position B, while causing the imaging device 66 to capture an image such that the distance between the first mobile body 10 and the second mobile body 12 is kept within a predetermined distance range until the first mobile body 10 reaches the second position B. For example, the second mobile body 12 sequentially measures the distance between the first mobile body 10 and the second mobile body 12, and stops moving toward the second position B if the distance exceeds the predetermined distance range. For example, if the distance between the first mobile body 10 and the second mobile body 12 exceeds the predetermined distance range, the second mobile body 12 stops (for example, hovers) at the spot. However, it is not limited thereto, and for example, the second mobile body 12 may stop moving toward the second position B, and move toward the first position A side until the distance between the first mobile body 10 and the second mobile body 12 is within the predetermined distance range. It is to be noted that the method of measuring the distance between the first mobile body 10 and the second mobile body 12 is optional. For example, the distance may be calculated by image analysis on the basis of the image of the first mobile body 10 captured by the imaging device 66. Alternatively, a distance measurement sensor such as LiDAR may be provided on the second mobile body 12, and the distance may be measured using the distance measurement sensor. Moreover, for example, at least one of the flying height of the second mobile body 12, a predetermined distance (distance allowed to be kept from the first mobile body 10), the imaging direction of the imaging device 66 on the second mobile body 12, and the angle of view of the imaging device 66 may be adjusted by the second mobile body command unit 92 of the remote control device 18. That is, the second mobile body command unit 92 of the remote control device 18 may output, to the second mobile body 12, a command for changing at least one of the flying height of the second mobile body 12, the predetermined distance, the imaging direction of the imaging device 66, and the angle of view of the imaging device 66, and cause the second mobile body 12 to change. This change command may be made automatically by the second mobile body command unit 92, or by an operator operating the remote control device 18.

Moreover, to measure the distance between the first mobile body 10 and the second mobile body 12, the second mobile body 12 may perform a process of specifying the first mobile body 10 serving as an object. In this case, for example, the second mobile body 12 may specify the first mobile body 10 by capturing an image of an identifier provided on the first mobile body 10 by the imaging device 66, and then reading the identifier. Consequently, the second mobile body 12 can move to the second position B such that the distance from the specified first mobile body 10 is kept within a predetermined distance range. Hence, for example, the second mobile body 12 can properly guide the first mobile body 10 serving as an object, without losing the sight of the first mobile body 10.

Upon reaching the target position (second position B or a position within a predetermined distance from the second position B), the second mobile body 12 may stop at the spot.

### Reaching Second Position

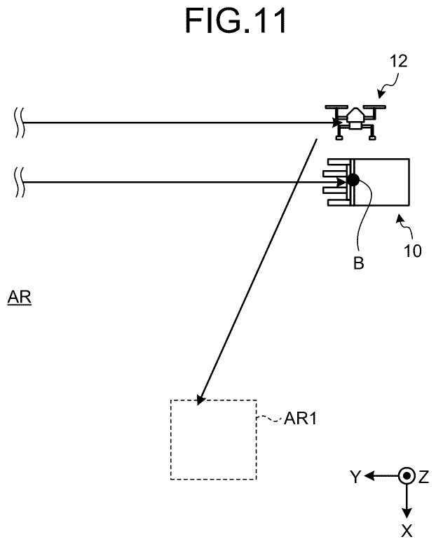

FIG. 11 is a schematic diagram illustrating an example when the first mobile body has reached the second position. When the first mobile body 10 reaches the second position B, the second mobile body command unit 92 of the remote control device 18 outputs a termination command to terminate the assistance by the second mobile body 12, to the second mobile body 12. As illustrated in FIG. 11, upon receiving the termination command, the second mobile body 12 may return to the standby position AR1. It is to be noted that the criteria used by the second mobile body command unit 92 for determining whether the first mobile body 10 has reached the second position B, is optional. For example, if the operator determines that the first mobile body 10 has reached the second position B by checking the image P or the like, the operator may input an operation indicating the termination, to the input unit 80. When the operation indicating the termination is input, the second mobile body command unit 92 determines that the first mobile body 10 has reached the second position B, and outputs the termination command to the second mobile body 12. Moreover, for example, the second mobile body command unit 92 may determine whether the first mobile body 10 has reached the second position B on the basis of the position of the second mobile body 12. For example, because the second mobile body 12 is within a predetermined distance range from the first mobile body 10, when the second mobile body 12 reaches the target position, it is possible to assume that the first mobile body 10 is also in the vicinity of the second position B. Thus, for example, when the second mobile body 12 reaches the target position, the second mobile body command unit 92 may determine that the first mobile body 10 has reached the second position B.

### Processing Flow

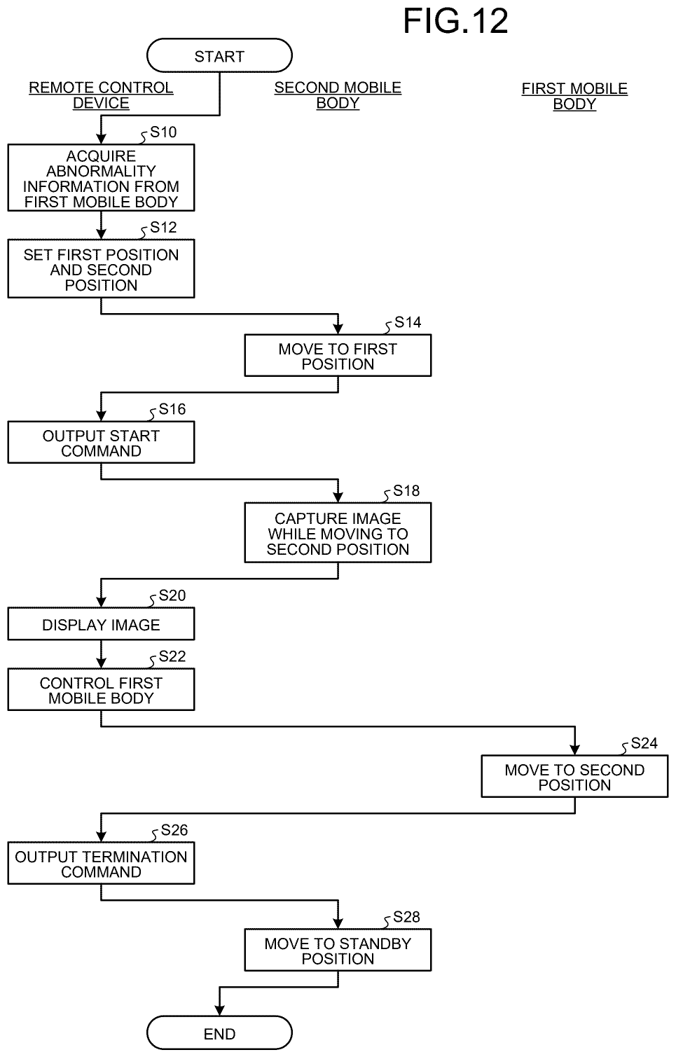

A processing flow of the movement control system 1 described above will now be described. FIG. 12 is a flowchart illustrating a processing flow of the movement control system according to the first embodiment. As illustrated in FIG. 12, when an abnormality occurs in the first mobile body 10, the remote control device 18 uses the information acquisition unit 90 to acquire abnormality information from the first mobile body 10 (step S10), uses the second mobile body command unit 92 to set the first position A and the second position B (step S12), and transmits information on the first position A and the second position B to the second mobile body 12. Upon acquiring the information on the first position A and the second position B, the second mobile body 12 moves toward the first position A (step S14), and transmits information indicating that the second mobile body 12 has reached the first position A, to the remote control device 18. Upon acquiring the information indicating that the second mobile body 12 has reached the first position A, the remote control device 18 outputs a start command to the second mobile body 12 (step S16). Upon acquiring the start command, the second mobile body 12 moves to the second position B while causing the imaging device 66 to capture an image (step S18). The remote control device 18 sequentially acquires the image data captured by the second mobile body 12 while moving to the second position B, and causes the display unit 82 to display the image P based on the acquired image data (step S20). The remote control device 18 receives an operation of an operator who is viewing the image P on the display unit 82, remotely controls the first mobile body 10 by the operation of the operator (step S22), and moves the first mobile body 10 toward the second position B (step S24). It is to be noted that the second mobile body 12 moves toward the second position B such that the distance from the first mobile body 10 is within a predetermined distance range. When the first mobile body 10 reaches the second position B, the remote control device 18 outputs a termination command to the second mobile body 12 (step S26). Upon acquiring the termination command, the second mobile body 12 terminates the work, and returns to the standby position AR1 (step S28).

As described above, in the first embodiment, the second mobile body 12 causes the imaging device 66 to capture an image of the surroundings while the distance from the first mobile body 10 is kept within a predetermined distance range, and the first mobile body 10 moves toward the second position B so as to follow the second mobile body 12. In this manner, in the first embodiment, the second mobile body 12 guides the first mobile body 10 while being positioned in the vicinity of the first mobile body 10. Hence, it is possible to properly evacuate the first mobile body 10 to the second position B. More specifically, the first mobile body 10 is guided to the second position B while the second mobile body 12 is caused to capture an image of the surroundings. Hence, the image can assist the remote control of the first mobile body 10 evacuating to the second position B, and it is possible to properly evacuate the first mobile body 10 to the second position B. More specifically, an imaging device for remote control may be provided on each of the first mobile bodies 10, and an imaging device for remote control may be provided in the facility W. However, if an imaging device for remote control is to be provided on each of the first mobile bodies 10, the number of imaging devices corresponding to the number of the installed first mobile bodies 10 will be required. Hence, the cost will be increased. Moreover, even when an imaging device is to be provided in the facility W, because it is not possible to assume in advance at which position the first mobile body 10 has an abnormality, a number of imaging devices need to be provided to cover all the areas. In contrast, in the present embodiment, the remote control of a plurality of the first mobile bodies 10 can be assisted by simply installing the second mobile body 12 provided with an imaging device for remote control. Hence, there is no need to provide a number of imaging devices, and the cost can be reduced.

It is to be noted that in the above description, the remote control device 18 remotely controls the movement of the first mobile body 10 to the second position B. However, for example, if the first mobile body 10 can move autonomously, the first control device 28A of the first mobile body 10 may allow the first mobile body 10 to move autonomously to the second position B without being remotely controlled by the remote control device 18. That is, for example, as an abnormal mode of the first mobile body 10, if the first control device 28A can control the movement of the first mobile body 10, but cannot detect the position of the first mobile body 10, the first control device 28A may allow the first mobile body 10 to move autonomously to the second position B. In this case, it is preferable that the first control device 28A causes the first mobile body 10 to move autonomously such that the first mobile body 10 tails the second mobile body 12 that is moving toward the second position B, that is, for example, such that the distance from the second mobile body 12 is kept within a predetermined distance range. It is to be noted that the method of measuring the distance between the first mobile body 10 and the second mobile body 12 is optional. For example, the distance may be calculated on the basis of the image of the first mobile body 10 captured by the imaging device 66, or the sensor 26A may measure the distance to the second mobile body 12.

### Second Modification

Next, a second modification will be described. The second embodiment is different from the first embodiment in that the second mobile body 12 is not caused to guide the first mobile body 10, and the first mobile body 10 is moved while the second mobile body 12 is made to stay on the first mobile body 10. In the second embodiment, the description of the parts having the same configuration as that of the first embodiment will be omitted.

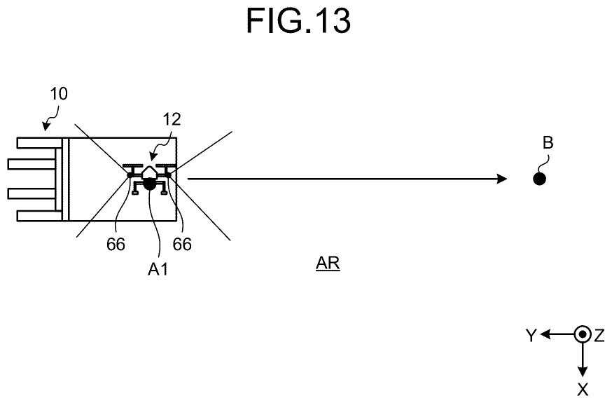

FIG. 13 is a schematic diagram illustrating a case when the second mobile body is made to stay on the first mobile body. As illustrated in FIG. 13, when the second mobile body 12 moves to the first position A, the second mobile body 12 moves to a fixed position A1 on the first mobile body 10, and stays at the fixed position A1. The fixed position A1 is not a position in the coordinate system of the area AR, but is a position in the coordinate system of the first mobile body 10, and may be referred to as a position fixed with respect to the reference position of the first mobile body 10. The fixed position A1 may be any position on the first mobile body 10. For example, upon reaching the first position A, the second mobile body 12 may detect a position where the second mobile body 12 can stay on the second mobile body 12 as the fixed position A1, move to the fixed position A1, and stay at the spot.

It is to be noted that the second mobile body command unit 92 of the remote control device 18 may remotely control at least one of the position and posture of the second mobile body 12 that has reached the first position A. The second mobile body 12 may move to the fixed position A1 by remote control by the remote control device 18, or may move autonomously to the fixed position A1, and at least one of the position and posture may be remotely controlled at the fixed position A1.

While staying at the fixed position A1, the second mobile body 12 causes the imaging device 66 to capture an image of the surroundings, and transmits the captured image data to the remote control device 18. While causing the display unit 82 to display the image P based on the image data acquired from the second mobile body 12, the remote control device 18 moves the first mobile body 10 toward the second position B. Specifically, the operator remotely operates the first mobile body 10 to reach the second position B while viewing the image P and checking the approximate position of the first mobile body 10.

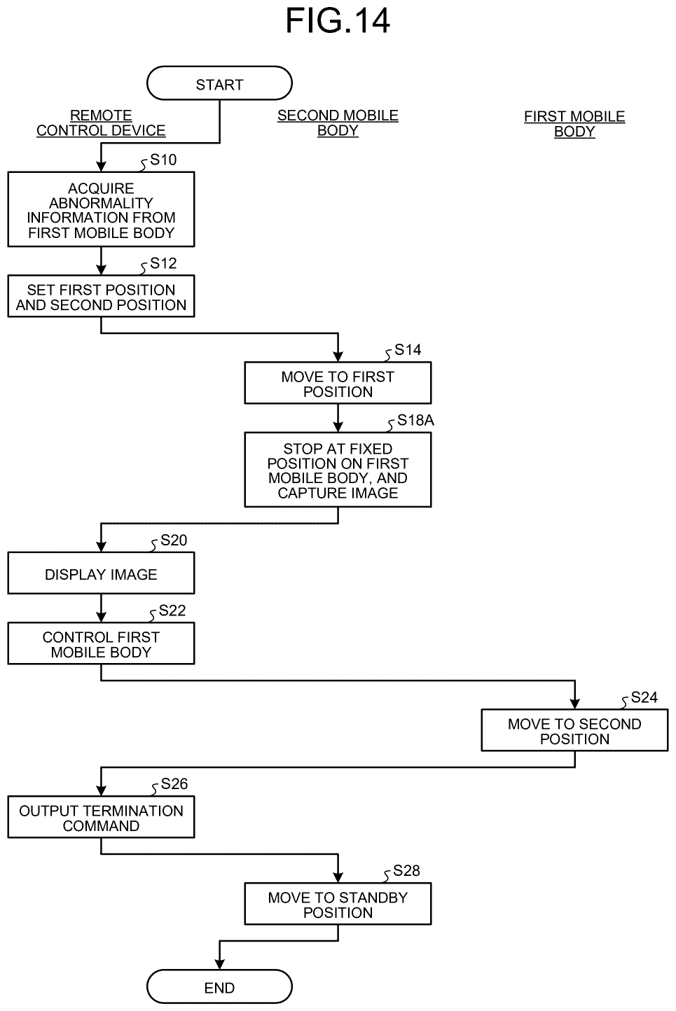

Next, a processing flow of the movement control system 1 in the second embodiment will be described. FIG. 14 is a flowchart illustrating a processing flow of the movement control system according to the second embodiment. Because steps up to step S14 in FIG. 14 are the same as those in the first embodiment, the description thereof will be omitted. When the second mobile body 12 reaches the first position A at step S14 in FIG. 14, the second mobile body 12 moves to and stays at the fixed position A1 on the first mobile body 10, and causes the imaging device 66 to capture an image (step S18A). The remote control device 18 sequentially acquires the image data captured by the second mobile body 12 at the fixed position A1, and causes the display unit 82 to display the image P based on the acquired image data (step S20). The remote control device 18 receives an operation of an operator who is viewing the image P on the display unit 82, remotely controls the first mobile body 10 by the operation of the operator (step S22), and moves the first mobile body 10 toward the second position B (step S24). When the first mobile body 10 reaches the second position B, the remote control device 18 outputs a termination command to the second mobile body 12 (step S26). Upon acquiring the termination command, the second mobile body 12 terminates the work, and returns to the standby position AR1 (step S28).

As described above, in the second embodiment, the imaging device 66 is caused to capture an image of the surroundings while the second mobile body 12 is positioned at the fixed position A1 on the first mobile body 10 that is proceeding toward the second position B. Therefore, the first mobile body 10 can be moved to the second position B while causing the second mobile body 12 to capture an image of the surroundings of the first mobile body 10. Hence, it is possible to properly assist the movement of the first mobile body 10 to the second position B by the image of the second mobile body 12.

It is to be noted that in the second embodiment also, the remote control device 18 may remotely control the first mobile body 10 automatically. In this case, for example, the first mobile body control unit 96 may calculate the position information of the first mobile body 10 from the position information of the second mobile body 12 that is staying at the fixed position A1 of the first mobile body 10, and move the first mobile body 10 by remote control so that the first mobile body 10 reaches the second position B. Moreover, in the second embodiment also, if the first mobile body 10 can move autonomously, the first mobile body 10 may move autonomously to the second position B by using the first control device 28A of the first mobile body 10 without being remotely controlled by the remote control device 18. In this case, the first control device 28A may calculate the position information of the first mobile body 10 from the position information of the second mobile body 12 that is staying at the fixed position A1 of the first mobile body 10, and move the first mobile body 10 so that the first mobile body 10 reaches the second position B. In such a control, the position information of the second mobile body 12 may be treated as the position information of the first mobile body 10.

Moreover, the first embodiment and the second embodiment may be combined with one another. That is, for example, after causing the second mobile body 12 to stay temporarily at the fixed position A1, the second mobile body 12 may be moved toward the second position B.

### Effects

The movement control method according to a first aspect of the present disclosure includes a step of moving the second mobile body 12 including the imaging device 66 to the first position A toward the first mobile body 10 when an abnormality occurs in the first mobile body 10, and a step of moving the first mobile body 10 to the second position B when the second mobile body 12 reaches the first position A. In the present control method, the imaging device 66 is caused to capture an image of the surroundings, while the second mobile body 12 is positioned within a predetermined distance range from the first mobile body 10, until the first mobile body 10 reaches the second position B. According to the present disclosure, when the first mobile body 10 cannot move autonomously according to the route, the second mobile body 12 is moved to the vicinity of the first mobile body 10, and is caused to capture an image of the surroundings, while the second mobile body 12 is positioned in the vicinity of the first mobile body 10, until the first mobile body 10 moves to the second position B. Therefore, according to the present disclosure, the first mobile body 10 can be moved to the second position B, while checking the surroundings of the first mobile body 10 by the image captured by the second mobile body 12. Hence, it is possible to properly move (guide) the first mobile body 10 to the second position B.

The movement control method according to a second aspect of the present disclosure is the movement control method according to the first aspect, in which at the step of moving the first mobile body 10 to the second position B, the second mobile body 12 is moved toward the second position B while the distance from the first mobile body 10 is kept within a predetermined distance range, the imaging device 66 is caused to capture an image of the surroundings while the second mobile body 12 is moved toward the second position B, and the first mobile body 10 is moved so as to follow the second mobile body 12. Therefore, according to the present disclosure, the second mobile body 12 can guide the first mobile body 10 while the second mobile body 12 is positioned in the vicinity of the first mobile body 10. Hence, it is possible to properly evacuate the first mobile body 10 to the second position B.

The movement control method according to a third aspect of the present disclosure is the movement control method according to the first aspect or second aspect, in which at the step of moving the first mobile body 10 to the second position B, the imaging device 66 is caused to capture an image of the surroundings while the second mobile body 12 is positioned at the fixed position A1 on the first mobile body 10 that is proceeding toward the second position B. According to the present disclosure, it is possible to move the first mobile body 10 to the second position B while causing the second mobile body 12 to capture an image of the surroundings of the first mobile body 10. Hence, it is possible to properly assist the movement of the first mobile body 10 to the second position B by the image of the second mobile body 12.

The movement control method according to a fourth aspect of the present disclosure is the movement control method according to any one of the first aspect to the third aspect, and further includes a step of displaying the image P1 based on the image data captured by the imaging device 66 and the image P2 indicating the position of the second mobile body 12, while the first mobile body 10 is moving to the second position B. According to the present disclosure, because the images P1 and P2 are displayed, it is possible to properly assist the movement of the first mobile body 10.

The movement control method according to a fifth aspect of the present disclosure is the movement control method according to the fourth aspect, in which at the step of displaying the image, information indicating the route along which the second mobile body 12 moves is displayed on the image P1 based on the image data captured by the imaging device 66 in a superimposed manner. According to the present disclosure, the information indicating the route along which the second mobile body 12 moves is displayed in a superimposed manner. Hence, it is possible to more properly assist the movement of the first mobile body 10 to the second position B.

The movement control method according to a sixth aspect of the present disclosure is the movement control method according to any one of the first aspect to the fifth aspect, in which at the step of moving the first mobile body 10 to the second position B, the first mobile body 10 is moved by the remote control device 18 provided at a position distant from the first mobile body 10. According to the present disclosure, the remote control device 18 can properly move the first mobile body 10 in which an abnormality has occurred to the second position B.

A program according to a seventh aspect of the present disclosure causes a computer to execute a step of moving the second mobile body 12 including the imaging device 66 to the first position A toward the first mobile body 10 when an abnormality occurs in the first mobile body 10, and a step of moving the first mobile body 10 to the second position B when the second mobile body 12 reaches the first position A. In the present program, the imaging device 66 is caused to capture an image of the surroundings, while the second mobile body 12 is positioned within a predetermined distance range from the first mobile body 10, until the first mobile body 10 reaches the second position B. According to the present disclosure, it is possible to properly move the first mobile body 10 in which an abnormality has occurred to the second position B.

The movement control system 1 according to an eighth aspect of the present disclosure includes the first mobile body 10 and the second mobile body 12 including the imaging device 66. When an abnormality occurs in the first mobile body 10, the second mobile body 12 moves to the first position A toward the first mobile body 10, and when the second mobile body 12 reaches the first position A, the first mobile body 10 moves to the second position B. The second mobile body 12 causes the imaging device 66 to capture an image of the surroundings, while remaining within a predetermined distance range from the first mobile body, until the first mobile body 10 reaches the second position B. According to the present disclosure, it is possible to properly move the first mobile body 10 in which an abnormality has occurred to the second position B.

The embodiments of the present disclosure have been described above; however, an embodiment is not limited to the contents of the embodiments. Moreover, the components described above include those that can be easily assumed by those skilled in the art, those that are substantially the same, and those that fall within what is called range of equivalents. Furthermore, the components described above can be combined with each other as appropriate. Still furthermore, various omissions, substitutions, or modifications of the components may be made without departing from the gist of the embodiments described above.

### REFERENCE SIGNS LIST

1 Movement control system
10 First mobile body
12 Second mobile body
18 Remote control device
28A First control device
28B Second control device
A First position
B Second position

1. A movement control method, comprising:
setting a first position toward a first mobile body and a second position that is an evacuation destination of the first mobile body when an abnormality occurs in the first mobile body, and setting a first moving route to the first position and a second moving route to the second position;
moving a second mobile body including an imaging device to the first position toward the first mobile body based on the first moving route; and
moving the first mobile body and the second mobile body to a second position based on the second moving route when the second mobile body reaches the first position, wherein
the moving the first mobile body to the second position includes causing the imaging device to capture an image of a surrounding while positioning the second mobile body within a predetermined distance range from the first mobile body, until the first mobile body reaches the second position.

2. The movement control method according to claim 1, wherein
the moving the first mobile body to the second position includes
moving the second mobile body toward the second position while keeping a distance from the first mobile body within the predetermined distance range,
causing the imaging device to capture an image of the surrounding while moving the second mobile body toward the second position, and
moving the first mobile body so as to follow the second mobile body.

3. The movement control method according to claim 1, wherein
the moving the first mobile body to the second position includes causing the imaging device to capture an image of the surrounding while positioning the second mobile body at a fixed position on the first mobile body that is proceeding toward the second position.

4. The movement control method according to claim 1, further comprising
displaying an image based on image data captured by the imaging device and an image indicating a position of the second mobile body, while the first mobile body is moving to the second position.

5. The movement control method according to claim 4, wherein the displaying the image includes displaying, on the image based on the image data captured by the imaging device in a superimposed manner, information indicating a route along which the second mobile body moves.

6. The movement control method according to claim 1, wherein
the moving the first mobile body to the second position includes moving the first mobile body by a remote control device provided at a position distant from the first mobile body.

7. A non-transitory computer-readable recording medium having stored thereon machine-readable instructions that cause a computer to execute:
setting a first position toward a first mobile body and a second position that is an evacuation destination of the first mobile body when an abnormality occurs in the first mobile body, and setting a first moving route to the first position and a second moving route to the second position;
moving a second mobile body including an imaging device to the first position toward the first mobile body based on the first moving route; and
moving the first mobile body and the second mobile body to a second position based on the second moving route when the second mobile body reaches the first position, wherein the step of moving the first mobile body to the second position includes causing the imaging device to capture an image of a surrounding while positioning the second mobile body within a predetermined distance range from the first mobile body, until the first mobile body reaches the second position.

8. A movement control system, comprising:
a first mobile body;
a second mobile body including an imaging device; and
a remote control device, wherein
the remote control device sets a first position toward a first mobile body and a second position that is an evacuation destination of the first mobile body when an abnormality occurs in the first mobile body, and sets a first moving route to the first position and a second moving route to the second position,
the second mobile body moves to a first position toward the first mobile body based on the first moving route when an abnormality occurs in the first mobile body,
the first mobile body and the second mobile body move to a second position based on the second moving route when the second mobile body reaches the first position, and
the second mobile body causes the imaging device to capture an image of a surrounding while remaining within a predetermined distance range from the first mobile body, until the first mobile body reaches the second position.

9. A movement control method, comprising:
moving a second mobile body including an imaging device to a first position toward a first mobile body when an abnormality occurs in the first mobile body; and
moving the first mobile body to a second position when the second mobile body reaches the first position, wherein
the moving of the first mobile body to the second position includes causing the imaging device to capture an image on a side opposite to a traveling direction of the second mobile body on a moving route of the second mobile body while positioning the second mobile body within a predetermined distance range from the first mobile body, until the first mobile body reaches the second position.

10. A non-transitory computer-readable recording medium having stored thereon machine-readable instructions that cause a computer to execute:
moving a second mobile body including an imaging device to a first position toward a first mobile body when an abnormality occurs in the first mobile body; and
moving the first mobile body to a second position when the second mobile body reaches the first position, wherein
the moving the first mobile body to the second position includes causing the imaging device to capture an image on a side opposite to a traveling direction of the second mobile body on a moving route of the second mobile body while positioning the second mobile body within a predetermined distance range from the first mobile body, until the first mobile body reaches the second position.

11. A movement control system, comprising:
a first mobile body; and
a second mobile body including an imaging device, wherein
the second mobile body moves to a first position toward the first mobile body when an abnormality occurs in the first mobile body,
the first mobile body moves to a second position when the second mobile body reaches the first position, and
the second mobile body causes the imaging device to capture an image on a side opposite to a traveling direction of the second mobile body on a moving route of the second mobile body while remaining within a predetermined distance range from the first mobile body, until the first mobile body reaches the second position.
